(19) United States
(12) Patent Application Publication
(10) Pub. No.: US 2025/0379215 A1
(43) Pub. Date: Dec. 11, 2025

(54) POSITIVE ELECTRODE ACTIVE MATERIAL FOR RECHARGEABLE LITHIUM BATTERY, POSITIVE ELECTRODE CONTAINING THE SAME, AND RECHARGEABLE LITHIUM BATTERY INCLUDING THE SAME

(71) Applicant: SAMSUNG SDI CO., LTD., Yongin-si (KR)

(72) Inventors: Soonsung SUH, Yongin-si (KR); Minju LEE, Yongin-si (KR); Boram LEE, Yongin-si (KR); Aram CHOI, Yongin-si (KR); Young-Ki KIM, Yongin-si (KR)

(73) Assignee: SAMSUNG SDI CO., LTD., Yongin-si (KR)

(21) Appl. No.: 19/073,676

(22) Filed: Mar. 7, 2025

(30) Foreign Application Priority Data
Jun. 11, 2024 (KR) 10-2024-0075485

(51) Int. Cl. H01M 4/36; H01M 4/02; H01M 4/136; H01M 4/58; H01M 4/62; H01M 10/052

(52) U.S. Cl. CPC H01M 4/364; H01M 4/136; H01M 4/366; H01M 4/5825; H01M 4/622; H01M 4/625; H01M 10/052; H01M 2004/021; H01M 2004/028

(57) ABSTRACT

Examples include a positive electrode active material for a rechargeable lithium battery, a positive electrode including the positive electrode active material, and a rechargeable lithium battery including the positive electrode active material. A positive electrode active material includes a first particle having an olivine crystal structure and having a first average particle diameter, a second particle having an olivine crystal structure and having a second average particle diameter smaller than the first average particle diameter, and a third particle having an olivine crystal structure and having a third average particle diameter larger than the first average particle diameter.

### CROSS-REFERENCE TO RELATED APPLICATIONS

This U.S. non-provisional patent application claims priority under 35 U.S.C. § 119 to Korean Patent Application No. 10-2024-0075485, filed on Jun. 11, 2024, the entire contents of which are hereby incorporated by reference.

### BACKGROUND

The present disclosure herein relates to a positive electrode active material for a rechargeable lithium battery, a positive electrode containing the positive electrode active material, and a rechargeable lithium battery including the positive electrode active material, and more particularly, to a positive electrode active material containing an olivine-based lithium compound, a positive electrode including the positive electrode active material, and a rechargeable lithium battery including the positive electrode active material.

With increasing use of battery-using electronic devices, such as,e.g., mobile phones, laptop computers, electric vehicles, and the like, demand for rechargeable batteries with high energy density and high capacity has increased.

A rechargeable lithium battery typically includes a positive electrode and a negative electrode containing an active material capable of intercalation and deintercalation of lithium ions, and an electrolyte solution. Electrical energy is produced by oxidation and reduction reactions when the lithium ions are intercalated and deintercalated into/from the positive electrode and the negative electrode.

### SUMMARY

The present disclosure relates to a positive electrode active material having high energy density and high conductivity.

The present disclosure also relates to a rechargeable lithium battery having high energy density and long lifespan.

An example embodiment of the present disclosure includes a positive electrode active material including a first particle having an olivine crystal structure and having a first average particle diameter, a second particle having an olivine crystal structure and having a second average particle diameter smaller than the first average particle diameter, and a third particle having an olivine crystal structure and having a third average particle diameter larger than the first average particle diameter. Each, or at least one, of the first to third particles may include a compound represented by Formula 1 below.

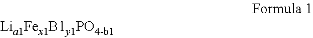

In Formula 1 above, 0.8≤a1≤1.2, 0.950≤x1≤0.999, 0.001≤y1≤0.05, 0≤b1≤0.05, and 0.99≤x1+y1≤1.01 may be satisfied, and B1 may be or include at least one element including at least one of Ti and Mg.

In an example embodiment of the present disclosure, a positive electrode for a rechargeable lithium battery may include a positive electrode current collector, and a positive electrode active material layer on the positive electrode current collector, and the positive electrode active material layer may include the above-described positive electrode active material, a conductive material, and a binder.

### BRIEF DESCRIPTION OF THE FIGURES

The accompanying drawings are included to provide a further understanding of the present disclosure, and are incorporated in, and constitute a part of, this specification. The drawings illustrate example embodiments of the present disclosure and, together with the description, serve to explain principles of the present disclosure. In the drawings:

FIG. 1 is a simplified conceptual diagram illustrating a rechargeable lithium battery according to example embodiments of the present disclosure;

FIGS. 2 to 5 are cross-sectional views schematically illustrating a rechargeable lithium battery according to an example embodiment;

FIG. 6 is an enlarged view of a positive electrode active material layer of a rechargeable lithium battery according to example embodiments of the present disclosure;

FIGS. 7 and 8 are flowcharts each showing a preparation method of a positive electrode active material according to an example embodiment of the present disclosure; and

FIGS. 9A to 9C are scanning electron microscope (SEM) images of a positive electrode active material, according to example embodiments of the present disclosure.

### DETAILED DESCRIPTION

In order to fully understand the configuration and effect of the present disclosure, example embodiments of the present disclosure will be described below in more detail with reference to the accompanying drawings. The present disclosure may, however, be embodied in various forms and should not be construed as limited to the example embodiments set forth herein, and various changes and modifications can be made. Rather, these example embodiments are provided so that this disclosure will be thorough and complete, and will fully convey the scope of the present disclosure to those skilled in the art to which the present disclosure pertains.

In this specification, it will be understood that, when an element is referred to as being “on” another element, the element may be directly on the other element or intervening elements may be present therebetween. In the drawings, thicknesses of components may be exaggerated for more effectively explaining the technical contents. Like reference numerals or symbols refer to like elements throughout the specification.

The singular forms are intended to include the plural forms as well, unless the context clearly indicates otherwise. In addition, unless otherwise specially noted, the phrase “A or B” may indicate “including A but not B, B but not A, or A and B.” The terms “comprises/includes” and/or “comprising/including” used in this specification do not exclude the presence or addition of one or more other components.

In this specification, “combination thereof” may refer to a mixture, a stack, a composite, a copolymer, an alloy, a blend, and a reaction product of components.

Unless otherwise defined in this specification, a particle diameter may be an average particle diameter. Also, the particle diameter means an average particle diameter (D50) which refers to a diameter of particles at a cumulative volume of about 50 vol % in a particle size distribution. The average particle diameter (D50) may be measured by a method widely known to those skilled in the art, for example, may be measured by a particle size analyzer, or may also be measured using a transmission electron microscope (TEM) image or a scanning electron microscope (SEM) image. Alternatively, the average particle diameter is measured by a measuring device using dynamic light-scattering, wherein the number of particles is counted for each particle size range by performing data analysis, and an average particle diameter (D50) value may then be obtained by calculation therefrom. Also, the average particle diameter may be measured using a laser diffraction method. When measured by the laser diffraction method, specifically, after dispersing particles to be measured in a dispersion medium, the dispersion medium is introduced into a commercial laser diffraction particle size measurement instrument (e.g., Microtrac MT 3000) and irradiated with ultrasonic waves of about 28 kHz at an output of about 60 W, and the average particle diameter (D50) based on about 50% of particle size distribution in the measurement instrument may then be calculated.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

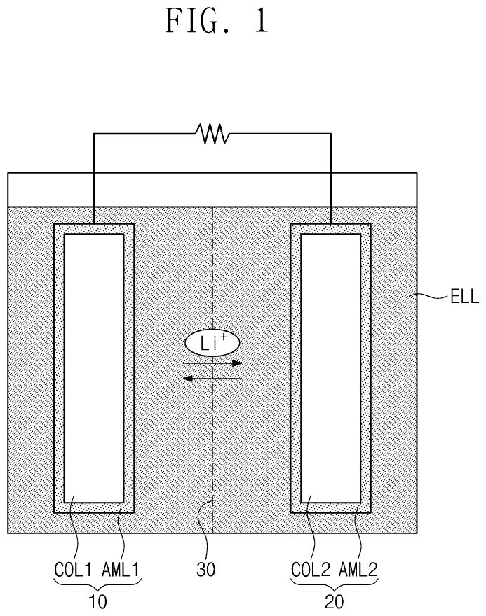

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other with the separator 30 therebetween. The separator 30 may be disposed between the positive electrode 10 and the negative electrode 20. The positive electrode 10, the negative electrode 20, and the separator 30 may be in contact with the electrolyte solution ELL. The positive electrode 10, the negative electrode 20, and the separator 30 may be impregnated in the electrolyte solution ELL.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

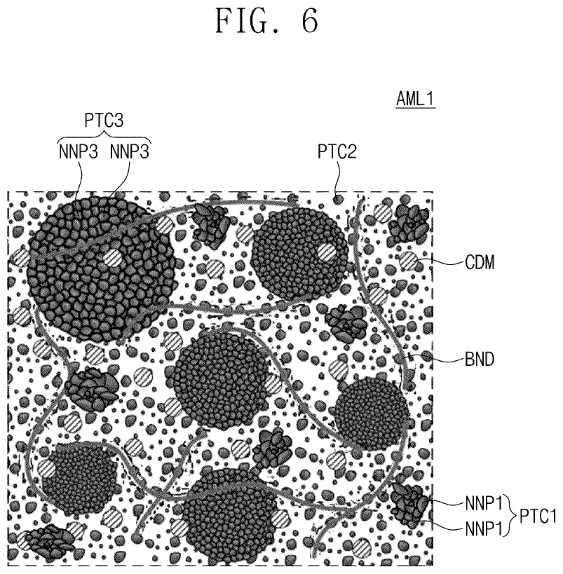

The positive electrode 10 for a rechargeable lithium battery may include a current collector COL1 and a positive electrode active material layer AML1 formed on the current collector COL1. The positive electrode active material layer AML1 may include a positive electrode active material, and may further include a binder and/or a conductive material. For example, the positive electrode 10 may further include an additive that may constitute a sacrificial positive electrode. The positive electrode active material layer AML1, according to example embodiments of the present disclosure, will be described later in detail with reference to FIG. 6. A1 may be included in the current collector COL1, but the material of the current collector COL1is not limited thereto.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include a range of about 90 wt % to about 99 wt % of negative electrode active material, about 0.5 wt % to about 5 wt % of binder, and about 0 wt % to about 5 wt % of conductive material.

The binder may be configured to attach the negative electrode active material particles to each other and also to attach the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical conductivity) to the electrode. Any material that does not cause chemical change (e.g., does not cause an undesirable chemical change in the rechargeable lithium battery), and that conducts electrons, may be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, etc. in a form of a metal powder or a metal fiber; a conductive polymer such as a polyphenylene derivative; or a mixture thereof.

The negative current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be or include graphite such as non-shaped, sheet-shaped, flake-shaped, sphere-shaped, or fiber-shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may include at least one of Sn, SnO2, a Sn-based alloy, or a combination thereof.

The silicon-carbon composite may be or include a composite of silicon and amorphous carbon. According to an example embodiment, the silicon-carbon composite may be in the form of silicon particles and amorphous carbon applied onto the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type of the rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one or both surfaces of the porous substrate.

The porous substrate may be or include a polymer film formed of or including any one polymer including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may be or include a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more solvents.

In addition, when using a carbonate-based solvent, a cyclic carbonate and a chain carbonate may be mixed and used, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluoro(oxalato)borate(LiDFOB), lithium difluorobis(oxalato)phosphate (LiDFBOP), and lithium bis(oxalato) borate (LiBOB).

### Rechargeable Lithium Battery

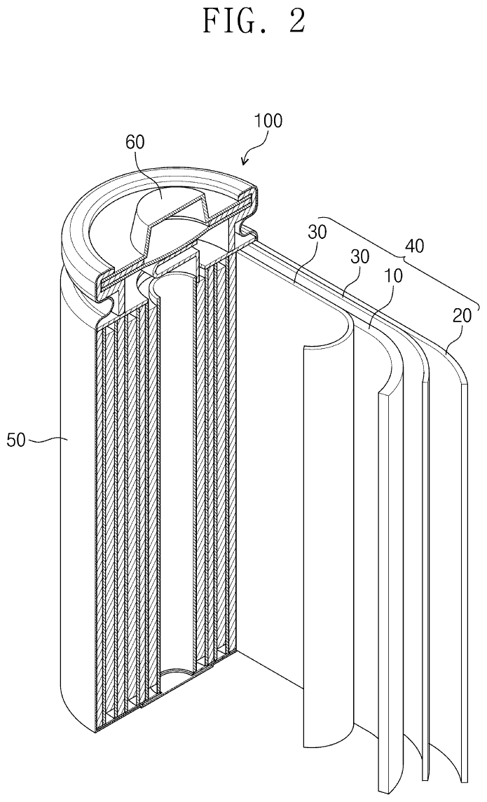

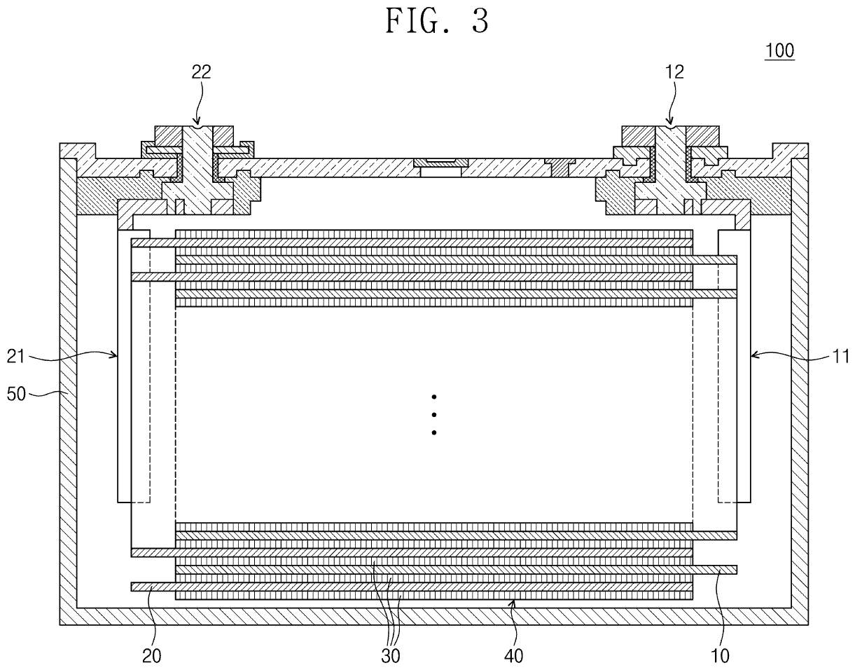

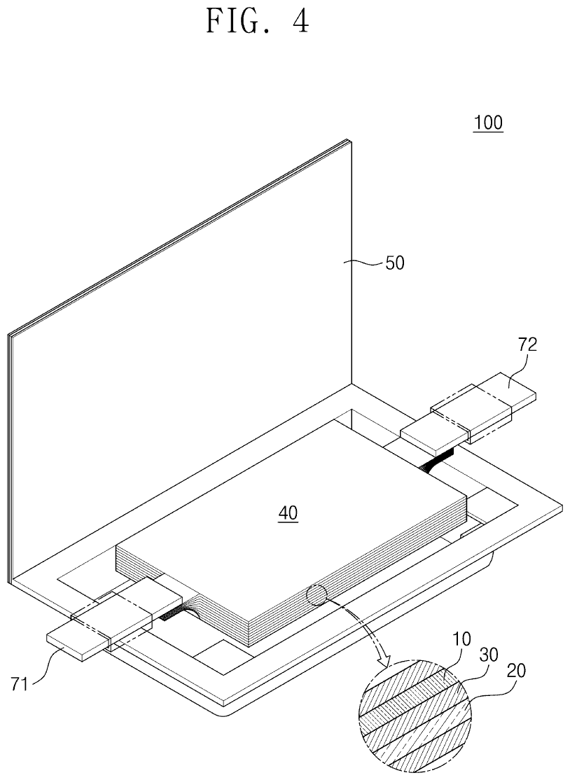

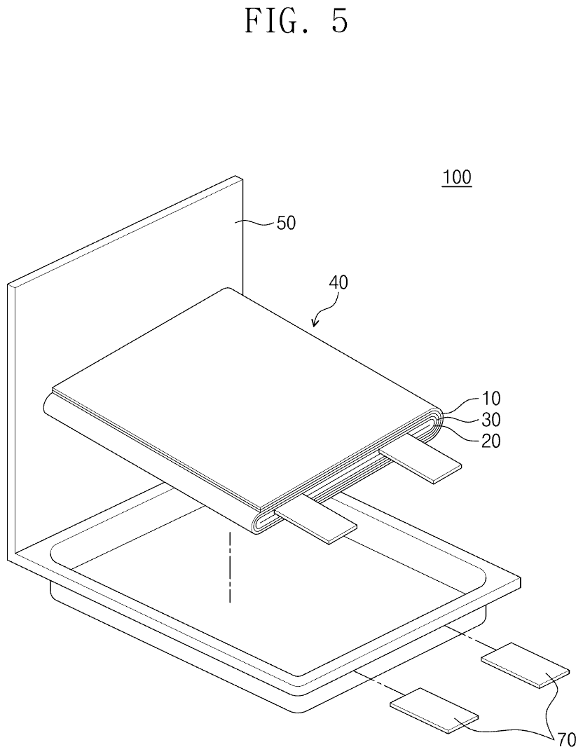

The rechargeable lithium battery may be classified into cylindrical, prismatic, pouch, coin-type batteries, and the like depending on their shape. FIGS. 2 to 5 are schematic views illustrating a rechargeable lithium battery according to an example embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the tabs 70/71/72 forming an electrical path for inducing the current formed in the electrode assembly 40 to the outside of the battery 100.

The rechargeable lithium battery according to an example embodiment may be applicable to automobiles, mobile phones, and/or various types of electric devices, as non-limiting examples.

FIG. 6 is an enlarged view of a positive electrode active material layer of a rechargeable lithium battery according to example embodiments of the present disclosure. Referring to FIG. 6, as previously described, the positive electrode active material layer AML1 (see FIG. 1) may include a first particle PTC1, a second particle PTC2, a third particle PTC3, a conductive material CDM, and a binder BND. A plurality of first particles PTC1, a plurality of second particles PTC2, and a plurality of third particles PTC3 may constitute a positive electrode active material according to example embodiments of the present disclosure.

An amount of the positive electrode active material PTC1, PTC2, and PTC3 in the positive electrode active material layer AML1 may be in a range of about 90 wt % to about 99.5 wt % with respect to 100 wt % of the positive electrode active material layer AML1. An amount of each of the binder BND and the conductive material CDM may be in a range of about 0.5 wt % to about 5 wt % with respect to 100 wt % of the positive electrode active material layer AML1.

The binder BND may bind the first particle PTC1, the second particle PTC2, the third particle PTC3, and the conductive material CDM to each other. For example, the binder BND may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but an example embodiment of the present disclosure is not limited thereto.

The conductive material CDM may be configured to improve conductivity of the positive electrode active material layer AML1. Any conductive material that does not cause chemical change of the positive electrode active material layer AML1 may be used, without limitation, as the conductive material CDM. Examples of the conductive material CDM may include a carbon-based material such as at least one of natural graphite, artificial graphite, carbon black, acetylene black, ketjen black, a carbon fiber, a carbon nanofiber, and a carbon nanotube; a metal-based material containing at least one of copper, nickel, aluminum, silver, etc., in a form of a metal powder or a metal fiber; a conductive polymer such as a polyphenylene derivative; or a mixture thereof.

Hereinafter, each of the first to third particles PTC1, PTC2, and PTC3 will be described in more detail.

### First Particle PTC1

The first particle PTC1 may have a polycrystal form, and may include a secondary particle in which at least two first primary particles NNP1 are aggregated. In other words, one first particle PTC1 may include a plurality of first primary particles NNP1 that are aggregated with each other. The first particle PTC1 may have a sphere shape, and may also have a non-sphere shape. That is, the first particle PTC1 may have a random shape.

In an example embodiment, the first particle PTC1 may include a coating layer on a surface thereof. The coating layer may cover the entire surface of the first particle PTC1, or may cover a portion of the surface of the first particle PTC1. For example, the coating layer may include carbon and/or a carbon-containing compound. The first particle PTC1 may exhibit improved structural stability and electrical conductivity due to the coating layer.

The coating layer may further include at least one of a titanium-containing compound, a magnesium-containing compound, and a vanadium-containing compound. A metal-containing compound, such as the titanium-containing compound, the magnesium-containing compound, and the vanadium-containing compound, may be or include, for example, at least one of a metal oxide, a metal hydroxide, a metal carbonate, or a composite or mixture thereof. The metal-containing compound may further include another metal or non-metal element. For example, the metal-containing compound may further include lithium.

In an example embodiment, the first particle PTC1 may further include a grain boundary coating layer on surfaces of the first primary particles NNP1. The grain boundary coating layer may be present inside the first particle PTC1. The grain boundary coating layer may be formed along an interface between the first primary particles NNP1 inside the first particle PTC1. In other words, the grain boundary coating layer may refer to a material applied to the grain boundary inside the first particle PTC1. The grain boundary coating layer may include carbon and/or a carbon-containing compound. The grain boundary coating layer may further include at least one of a titanium-containing compound, a magnesium-containing compound, and a vanadium-containing compound.

The inside of the first particle PTC1 may refer to an entire inner region of the first particle PTC1 excluding the surface of the first particle PTC1. For example, the inside of the first particle PTC1 may refer to an entire inner region from about 10 nm depth from the outer surface of the first particle PTC1, or a region from a range of about 10 nm depth to about 2 μm depth.

Since the first particle PTC1 further includes a grain boundary coating part, structural stability may be strengthened, and a coating layer may be formed uniformly on the surface of the first particle PTC1. In addition, since the first particle PTC1 further includes the grain boundary coating part, the electrical conductivity of the first particle PTC1 may be further improved.

The first particle PTC1 may include carbon derived from the above-described coating layer and/or grain boundary coating layer. An amount of carbon element in the first particle PTC1 may be in a range of about 1.1 wt % to about 2.0 wt %, about 1.4 wt % to about 2.0 wt %, or about 1.4 wt % to about 1.7 wt %. The amount of carbon element in the first particle PTC1 may be greater than an amount of carbon element in the second particle PTC2 to be described later, and less than an amount of carbon element in the third particle PTC3 to be described later.

Analysis on a carbon element according to example embodiments of the present disclosure may be performed using an Elementar Micro Cube elemental analyzer. The specific operation method and conditions are as follows. A sample of about 1 to 2 mg is weighed in a tin cup, placed in an automatic sampling tray and introduced into a combustion tube through a ball valve, and the combustion is carried out at a combustion temperature of about 1000° C. Subsequently, reduction of the combustion gas using reduced copper is carried out to form carbon dioxide. Carbon dioxide was detected using a thermal conductivity detector (TCD).

Scanning electron microscope-energy dispersive X-ray spectroscopy (SEM-EDS) and quantitative analyses on a particle surface were conducted to measure the carbon content according to example embodiments of the present disclosure. In addition to SEM-EDS, inductively coupled plasma-mass spectrometry (ICP-MS), inductively coupled plasma optical emission spectroscopy (ICP-OES), or the like may be used to measure the carbon content.

The first particle PTC1 may have an average particle diameter in a range of about 1 μm to about 7 μm, about 1 μm to about 5 μm, or about 2 μm to about 4 μm. For example, a first average particle diameter of the first particle PTC1 may be about 3 μm. In an example embodiment, the average particle diameter may be measured with a particle size analyzer. The average particle diameter may refer to a diameter (D50) of particles at a cumulative volume of about 50 vol % in a particle size distribution. The first average particle diameter of the first particle PTC1 may be larger than a second average particle diameter of the second particle PTC2 to be described later, and smaller than a third average particle diameter of the third particle PTC3.

The first primary particles NNP1 of the first particle PTC1 may have an average size in a range of about 100 nm to about 500 nm, about 200 nm to about 400 nm, or about 200 nm to about 350 nm. In an example embodiment, the average size of the first primary particles NNP1 may refer to an average size of diameters obtained by measuring the diameters of a number of first primary particles NNP1 such as, e.g., about 30 first primary particles NNP1, randomly selected from an electron micrograph of a positive electrode active material. The average size of the first primary particles NNP1 may be larger than or equal to the average size of the second primary particles to be described later, and may be larger than the average size of the third primary particles NNP3.

The first particle PTC1 may have a form in which the nano-sized first primary particles NNP1 are aggregated. The first particle may have a substantially sphere shape, and may also have a non-sphere shape.

With the first primary particles NNP1 being aggregated with each other as previously described, the first particle PTC1 may have the following characteristics. The average particle diameter of the first particle PTC1 may be in a range of about 1 μm to about 5 μm. A porosity of the first particle PTC1 may be in a range of about 15% to about 20%, and may be less than a porosity of each of, or at least one of, the second and third particles PTC2 and PTC3 to be described later. The first particle PTC1 may have a specific surface area in a range of about 8 m²/g to about 12 m²/g, and a span value thereof, obtained by analysis on the first particle PTC1 using a particle size analyzer, may be in a range of about 1.33 to about 1.5.

### Second Particle PTC2

The second particle PTC2 may have a single particle form. In this disclosure, a “single” particle may refer to one particle, or a lone particle, that exists alone without a grain boundary therein. In terms of morphology, the single particle may refer to one particle, a monolith structure, a single unitary structure, or a non-aggregated particle, existing as an independent phase in which particles do not aggregate with each other. For example, the single particle may be a single crystal. Alternatively, the single particle may be or include a particle containing a few crystals. The single particle may be independently separated. Alternatively, the single particle may be in the form of about 2 to about 100 single particles bound to each other.

The second particle PTC2 may be or include a nano-shaped positive electrode active material. The second particle PTC2 may include at least one second primary particle. In an example embodiment, the second primary particles may also be aggregated with each other to have a particle shape similar to the particle shape of the first particle PTC1 previously described.

The second particle PTC2 may be provided in various sizes. For example, the second particle PTC2 may have an average particle diameter in a range of about 500 nm to about 2.5 μm, or of about 1 μm. A minimum particle diameter of the second particle PTC2, which is the particle diameter of the second primary particle, may be in a range of about 100 nm to about 500 nm, or about 100 nm to about 200 nm. In an example embodiment, the average particle diameter may be measured with a particle size analyzer. The average particle diameter may refer to a diameter (D50) of particles at a cumulative volume of about 50 vol % in a particle size distribution.

The porosity of the second particle PTC2 may be greater than about 40%, and may be greater than the porosity of the first particle PTC1. The span value, obtained by analysis on the second particle PTC2 using a particle size analyzer, may be outside the range of about 3.0 to about 3.95, for example, the span value is either lower than 3.0 or greater than 3.95.

In an example embodiment, the second particle PTC2 may include a coating layer on a surface thereof. The coating layer may cover the entire surface of the second particle PTC2, or may cover a portion of the surface of the second particle PTC2. For example, the coating layer may include carbon and/or a carbon-containing compound. The coating layer may further include at least one of a titanium-containing compound, a magnesium-containing compound, and a vanadium-containing compound. A metal-containing compound, such as the titanium-containing compound, the magnesium-containing compound, and the vanadium-containing compound, may be or include, for example, at least one of a metal oxide, a metal hydroxide, a metal carbonate, or a composite or mixture thereof. The metal-containing compound may further include another metal or non-metal element. For example, the metal-containing compound may further include lithium. The second particle PTC2 may have improved structural stability and electrical conductivity due to the coating layer.

The second particle PTC2 may include carbon derived from the coating layer previously described. An amount of carbon element in the second particle PTC2 may be in a range of about 0.5 wt % to about 5 wt %, about 0.5 wt % to about 3 wt %, or about 0.5 wt % to about 2 wt %. The amount of carbon in the second particle PTC2 may be less than the amount of carbon in the first particle PTC1. This is because it is challenging for the coating layer to be formed smoothly on the second particle PTC2, which is a single particle, compared with the first particle PTC1 which is or includes a secondary particle.

### Third Particle PTC3

The third particle PTC3 may have a polycrystal form, and may include a secondary particle in which a plurality of third primary particles NNP3 are aggregated. In other words, one third particle PTC3 may include a plurality of third primary particles NNP3 that are aggregated with each other. The average number of the third primary particles NNP3 included in the third particle PTC3 may be larger than the average number of the first primary particles NNP1 included in the first particle PTC1. The third particle PTC3 may have substantially a sphere or oval shape.

In an example embodiment, the third particle PTC3 may include a coating layer on a surface thereof. The coating layer may cover substantially the entire surface of the third particle PTC3, or may cover a portion of the surface of the third particle PTC3. For example, the coating layer may include carbon and/or a carbon-containing compound. The third particle PTC3 may have improved structural stability and electrical conductivity due to the coating layer.

The coating layer may further include at least one of a titanium-containing compound, a magnesium-containing compound, and a vanadium-containing compound. A metal-containing compound, such as the titanium-containing compound, the magnesium-containing compound, and the vanadium-containing compound, may be or include, for example, at least one of a metal oxide, a metal hydroxide, a metal carbonate, or a composite or mixture thereof. The metal-containing compound may further include another metal or non-metal element. For example, the metal-containing compound may further include lithium.

In an example embodiment, the third particle PTC3 may further include a grain boundary coating layer on surfaces of the third primary particles NNP3. The grain boundary coating layer may be present inside the third particle PTC3. The grain boundary coating layer may be formed along an interface between the third primary particles NNP3 inside the third particle PTC3. In other words, the grain boundary coating layer may refer to a material applied to the grain boundary inside the third particle PTC3. The grain boundary coating layer may include carbon and/or a carbon-containing compound. The grain boundary coating layer may further include at least one of a titanium-containing compound, a magnesium-containing compound, and a vanadium-containing compound.

The inside of the third particle PTC3, previously described, may refer to an entire inner region of the third particle PTC3 excluding the surface of the third particle PTC3. For example, the inside of the third particle PTC3 may refer to an entire inner region from about 10 nm depth from the outer surface of the third particle PTC3, or a region in a range from about 10 nm depth to about 2 μm depth.

Since the third particle PTC3 further includes a grain boundary coating part, structural stability may be strengthened, and a coating layer may be formed substantially uniformly on the surface of the third particle PTC3. In addition, since the third particle PTC3 further includes the grain boundary coating part, the electrical conductivity of the third particle PTC3 may be further improved.

The third particle PTC3 may include carbon derived from the above-described coating layer and/or grain boundary coating layer. An amount of carbon element in the third particle PTC3 may be in a range of about 0.5 wt % to about 10 wt %, about 1 wt % to about 3 wt %, or about 1.5 wt % to about 2.5 wt %. The amount of carbon element in the third particle PTC3 may be greater than the amount of carbon element in the first particle PTC1. This may be because the third particle PTC3 includes a larger number of primary particles and accordingly, the amount of carbon derived from the grain boundary coating layer is larger.

The third particle PTC3 may have an average particle diameter in a range of about 2 μm to about 15 μm, about 3 μm to about 10 μm, or about 3 μm to about 7 μm. For example, the third average particle diameter of the third particle PTC3 may be about 5 μm. The average particle diameter of the third particle PTC3 may be larger than the first average particle diameter of the first particle PTC1 previously described. In an example embodiment, the average particle diameter may be measured with a particle size analyzer. The average particle diameter may refer to a diameter (D50) of particles at a cumulative volume of about 50 vol % in a particle size distribution.

The third primary particle NNP3 of the third particle PTC3 may have a particle diameter in a range of about 10 nm to about 400 nm, about 20 nm to about 300 nm, about 50 nm to about 200 nm, or about 100 nm to about 200 nm. In an example embodiment, the average particle diameter of the third primary particles NNP3 may refer to an average value of diameters obtained by measuring the diameters of a number of third primary particles NNP3 such as, e.g., about 30 third primary particles NNP3, randomly selected from an electron micrograph of a positive electrode active material. The particle diameters of the third primary particles NNP3 may be uniform.

The third particle PTC3 may have a substantially sphere shape in which the nano-sized third primary particles NNP3 are aggregated. With the third primary particles NNP3 being closely aggregated with each other, the third particle PTC3 may have the following characteristics. The third particle PTC3 may have a substantially sphere or substantially oval shape. The average particle diameter (D50) of the third particle PTC3 may be in a range of about 2 μm to about 15 μm. The third particle PTC3 may have a porosity in a range of about 20% to about 40%. The porosity of the third particle PTC3 may be less than the porosity of the first particle PTC1. The span value, obtained by analysis on the third particle PTC3 with a particle size analyzer, may be in a range of about 0.44 to about 0.79.

Referring back to FIG. 6, a positive electrode active material according to example embodiments of the present disclosure will be described in more detail. The positive electrode active material according to an example embodiment of the present disclosure may include the first to third particles PTC1, PTC2, and PTC3. Each of the first to third particles PTC1, PTC2, and PTC3 may have an olivine crystal structure, and include a compound represented by Formula 1 below.

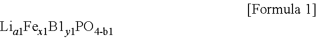

In Formula 1 above, 0.8≤a1≤1.2, 0.950≤x1≤0.999, 0.001≤y1≤0.05, 0≤b1≤0.05, and 0.99≤x1+y1≤1.01 may be satisfied. B1 may be or include at least one element including at least one of Ti and Mg. B may be or include a dopant doped into the positive electrode active material, and may control the sizes of primary particles to be uniform.

As including an olivine-based positive electrode active material, the positive electrode active material according to an example embodiment of the present disclosure may have desired or improved economic feasibility and stability. Furthermore, since a positive electrode according to an example embodiment of the present disclosure includes the first to third particles PTC1, PTC2, and PTC3 having different average particle diameters, the positive electrode may have improved mixture density and current density, compared with the case of including only one type of active material or the case of including only two types of active materials.

According to an example embodiment of the present disclosure, an amount of the first particle PTC1 may be in a range of about 50 wt % to about 85 wt % with respect to the total amount of the first to third particles PTC1, PTC2, and PTC3. For example, the amount of the first particle PTC1 may be in a range of about 50 wt % to about 75 wt % or about 50 wt % to about 65 wt %.

For example, a mixing ratio of the second particle PTC2 and the third particle PTC3 may be in a range of about 75:25 to about 25:75, or about 50:50 to about 25:75.

When the first to third particles PTC1, PTC2, and PTC3 have the above-mentioned mixing ratio, the positive electrode including the positive electrode active material according to an example embodiment of the present disclosure may have a desired or improved mixture density and current density, and a rechargeable lithium battery including the positive electrode active material according to an example embodiment of the present disclosure may have desired or improved lifespan characteristics.

The positive electrode including the positive electrode active material according to an example embodiment of the present disclosure may have an electrode-plate mixture density equal to or greater than about 2.5 g/cc. In an example embodiment, the mixture density of the positive electrode, according to an example embodiment of the present disclosure, may be about 2.5 g/cc to about 4.0 g/cc, or about 2.5 g/cc to about 3.5 g/cc.

The positive electrode including the positive electrode active material, according to an example embodiment of the present disclosure, may have a current density equal to or greater than about 4.0 mA/cm². In an example embodiment, the current density of the positive electrode according to an example embodiment of the present disclosure may be in a range of about 4.0 mA/cm² to about 6.0 mA/cm², or about 4.5 mA/cm² to about 5.5 mA/cm².

A rechargeable lithium battery including the positive electrode active material, according to an example embodiment of the present disclosure, may have a capacity retention rate of at least about 80% after at least about 10000 charging and discharging cycles with about 0.2 C/0.5 C at a voltage of about 2.5 V to about 3.65 V. For example, the capacity retention rate may be in a range of about 80% to about 95%, or about 80% to about 90%.

### Preparation Method of Positive Electrode Active Material

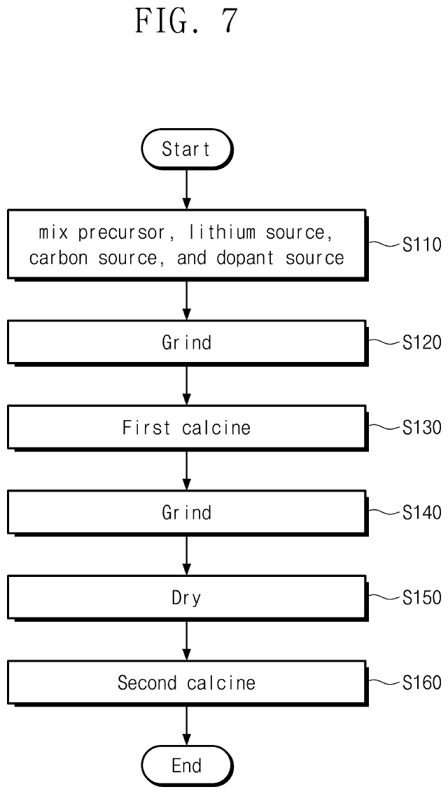

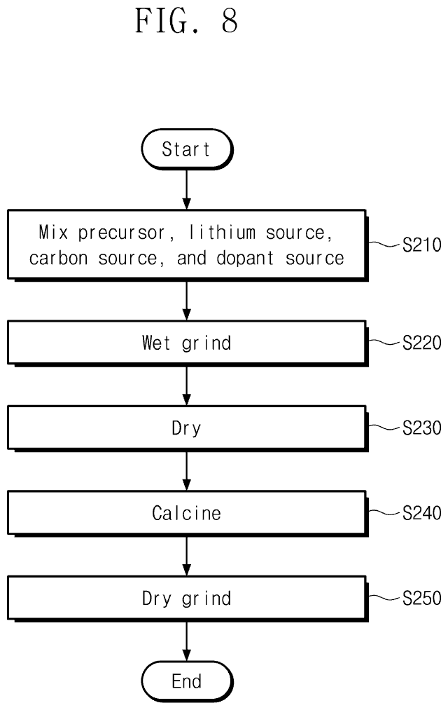

FIGS. 7 and 8 are flowcharts each showing a preparation method of a positive electrode active material, according to an example embodiment of the present disclosure. Referring to FIG. 7, preparation of a first particle PTC1 according to example embodiments of the present disclosure will be described in more detail.

An iron phosphate precursor, a lithium source, a carbon source, and a dopant source may be added to a solvent, and mixed (S110). For example, the solvent may be or include water, ethanol, etc. The iron phosphate precursor may be or include a compound containing both iron (Fe) and phosphorus (P), or a mixture of an iron (Fe)-containing compound and a phosphorus (P)-containing compound. For example, the iron phosphate precursor may be or include a mixture of FePO₄·H2O, FeSO₄, and H₃PO₄, or a mixture of (NH₄)2Fe(SO₄)·6H2O and H₃PO₄.

The lithium source may include at least one of lithium oxide, lithium hydroxide, lithium chloride, lithium nitrate, lithium nitrite, lithium formate, lithium acetate, lithium oxalate, lithium carbonate, lithium phosphate, dilithium hydrogen phosphate, lithium dihydrogen phosphate, and lithium citrate.

The carbon source may include at least one of glucose, sucrose, fructose, cellulose, starch, citric acid, polyacrylic acid, polyethylene glycol, and dopamine.

The dopant source may include a dopant metal-containing oxide and/or a dopant metal-containing chloride. For example, the dopant source may include at least one of titanium oxide, magnesium oxide, vanadium oxide, and niobium oxide.

Wet grinding may be performed on the mixture (S120). For the wet grinding, a general wet mill capable of temperature control may be used. In particular, at least one of a beads mill, a ball mill, an attrition mill, an apex mill, a super mill, and a basket mill may be used for the wet grinding. Through the wet grinding process, particles in the mixture may be ground to a fine size. According to an example embodiment of the present disclosure, the wet grinding may also be omitted.

First calcination may be performed on the ground mixture (S130). The first calcination may include performing heat treatment on the mixture under high-temperature and high-voltage solvent. In an example embodiment, the first calcination process may be performed in an autoclave reactor. The temperature at which the first calcination process is performed may be in a range of about 100° C. to about 500° C., or about 150° C. to about 300° C. The execution time of the first calcination process may be in a range of about 4 hours to about 20 hours, or about 6 hours to about 12 hours. As the dried mixture is calcined, the first particle PTC1 containing the compound represented by Formula 1, described above, may be formed.

Grinding may be performed on the calcined first particle PTC1 (S140). Accordingly, the first particle PTC1 may have a fine primary particle size.

Drying may be performed on the ground first particle PTC1 (S150). According to an example embodiment of the present disclosure, the drying may include performing spray drying on the mixture. A generally used spray-drying device may be used for the spray drying. For example, the spray drying may be performed by using at least one of an ultrasonic spray-drying device, an air nozzle spray-drying device, an ultrasonic nozzle spray-drying device, a filter expansion droplet-generating device, and an electrostatic spray-drying device.

The particles, finely reduced to the size of a primary particle after the wet grinding process, may be aggregated with each other through the spray drying process to thereby form a secondary particle. Therefore, by adjusting the flow amount and flow rate of carrier gas, temperature, the residence time in a reactor, internal pressure, and the like during the spray drying process, the first particle PTC1 may be formed into the secondary particle of a desired size.

In an example embodiment, the mixture to be spray-dried may have a total solid content (TSC) in a range of about 20% to about 30%. The total solid content may refer to a converted value to percentage of the weight of a solid material remaining after solvent evaporation (that is, dried mixture) with respect to the total weight of the mixture (that is, spray liquid). For example, the spray liquid may have a total solid content of about 25 wt %.

In an example embodiment, the spray drying may be performed at a temperature in a range of about 200° C. to about 400° C. Spray gas (for example, air), used for the spray drying, may be injected at a first temperature, and discharged at a second temperature. For example, the first temperature may be in a range of about 200° C. to about 250° C. The second temperature may be in a range of about 300° C. to about 400° C.

The spray liquid for the spray drying may have a flow rate in a range of about 10 ml/min to about 30 ml/min. The spray liquid may have an input pressure in a range of about 0.3 MPa to about 0.7 MPa. For example, the input pressure of the spray liquid may be about 0.5 MPa.

Second calcination may be performed after the spray drying (S160). The second calcination may be performed in an inert atmosphere. The inert atmosphere may be or include a nitrogen atmosphere and/or an argon atmosphere. The temperature at which the second calcination process is performed may be in a range of about 500° C. to about 1000° C., or about 600° C. to about 800° C. The execution time of the second calcination process may be in a range of about 4 hours to about 20 hours, or about 6 hours to about 12 hours. Since the second calcination is performed on the ground mixture, the first particle PTC1 in the form of a secondary particle may be formed.

Dry grinding may be performed on the calcined first particle PTC1. Through the grinding process, the size of the first particle that is a secondary particle may be adjusted. Meanwhile, the grinding process may be omitted.

Referring to FIG. 8, preparation of a second particle PTC2 according to example embodiments of the present disclosure will be described in more detail.

First, an iron phosphate precursor, a lithium source, a carbon source, and a dopant source may be added to a solvent and mixed (S210). For example, the solvent may be or include water, ethanol, etc. The iron phosphate precursor, the lithium source, the carbon source, and the dopant source may be the same as or similar to those discussed above for the preparation of the first particle PTC1.

Wet grinding may be performed on the mixture (S220). The wet grinding process may be the same as or similar to the wet grinding in the preparation of the first particle PTC1 previously described.

The solvent may be removed from the mixture to form a dried mixture (S230). The forming of the dried mixture may include performing direct evaporation on the mixture. For example, the direct evaporation may include static drying or spray drying. To form the second particle PTC2 into a single particle, it may be advantageous to use static drying.

The dried mixture may be calcined in an inert atmosphere (S240). The conditions of the calcination process may be the same as or similar to the conditions of the second calcination process of the first particle PTC1 described above. As the dried mixture is calcined, the second particle PTC2 containing the compound represented by Formula 1, described above, may be formed.

Dry grinding may be performed on the calcined second particle PTC2 (S250). Accordingly, the second particle PTC2 may have a single particle form.

Referring back to FIG. 8, preparation of a third particle PTC3 according to example embodiments of the present disclosure will be described in more detail. An iron phosphate precursor, a lithium source, a carbon source, and a dopant source may be added to a solvent, and mixed (S210). For example, the solvent may be or include water, ethanol, etc. The iron phosphate precursor, the lithium source, the carbon source, and the dopant source may be the same as or similar to those included in the preparation of the first particle PTC1 previously described.

Wet grinding may be performed on the mixture (S220). The wet grinding process may be the same as or similar to that in the preparation of the first particle PTC1 previously described.

The solvent may be removed from the mixture to form a dried mixture (S230). According to an example embodiment of the present disclosure, the forming of the dried mixture may include performing spray drying on the mixture. A spray-drying device may be the same as the device used in the preparation of the first particle PTC1.

The particles, finely reduced to a size of a primary particle after the wet grinding process, may be aggregated with each other through the spray drying process to thereby form a secondary particle. By varying the spray-drying conditions, a third particle may be formed in a different shape from the first particle. That is, by adjusting the flow amount and flow rate of carrier gas, temperature, the residence time in a reactor, internal pressure, and the like during the spray drying process, the third particle PTC3 may be formed into a secondary particle of a desired shape and size.

In an example embodiment, the mixture to be spray-dried may have a total solid content (TSC) in a range of about 20 wt % to about 40 wt %. The total solid content may refer to a converted value to percentage of the weight of a solid material remaining after solvent evaporation (that is, dried mixture) with respect to the total weight of the mixture (that is, spray liquid). For example, the spray liquid may have a total solid content of about 30 wt %.

When the total solid content is less than about 20 wt %, disadvantages in that an average particle diameter of the third particle PTC3 decreases and productivity is reduced may be caused. When the total solid content is greater than about 40 wt %, adjusting the average particle diameter of the third particle PTC3 may become challenging, and size difference between the third particles PTC3 may increase.

The spray liquid according to this example embodiment may have a viscosity in a range of about 1500 mPa·s to about 2500 mPa·s with the above-mentioned total solid content. For example, the spray liquid may have a viscosity of about 2000 mPa·s.

In an example embodiment, the spray drying may be performed at a temperature of about 100° C. to about 300° C. Spray gas (for example, air), used for the spray drying, may be injected at a first temperature, and discharged at a second temperature. For example, the first temperature may be in a range of about 200° C. to about 250° C. The second temperature may be in a range of about 80° C. to about 150° C.

The spray liquid for the spray drying may have a flow rate in a range of about 30 ml/min to about 80 ml/min. When the flow rate is less than about 30 ml/min, disadvantages of nozzle clogging, reduced productivity, and the like may be caused. When the flow rate is greater than about 80 ml/min, due to moisture condensation in the spray-drying device, the mixture may not be dried completely. The spray liquid may have an input pressure in a range of about 0.3 MPa to about 0.7 MPa. For example, the input pressure of the spray liquid may be about 0.5 MPa.

The dried mixture may be calcined in an inert atmosphere (S240). The inert atmosphere may be or include a nitrogen atmosphere and/or an argon atmosphere. The temperature at which the calcination process is performed may be in a range of about 500° C. to about 1000° C., or about 600° C. to about 800° C. The execution time of the calcination process may be in a range of about 4 hours to about 20 hours, or about 6 hours to about 12 hours. As the dried mixture is calcined, the third particle PTC3 containing the compound represented by Formula 1, described above, may be formed.

In the preparation of the third particle PTC3, according to an example embodiment of the present disclosure, the carbon source may be introduced to the iron phosphate precursor to form a carbon coating layer uniformly on surfaces of primary particles. Thereafter, the primary particles may be aggregated through the spray drying to form a secondary particle. As a result, the third particle PTC3 may include the stable carbon coating layer in the outside and inside of the third particle PTC3, and may thus have a relatively high carbon content. Due to the high carbon content of the third particle PTC3, a positive electrode active material layer AML1 may have improved conductivity.

By mixing the prepared first to third particles PTC1, PTC2, and PTC3 in an appropriate or desired ratio, the positive electrode active material according to example embodiments of the present disclosure may be formed.

Hereinafter, examples and comparative examples of the present disclosure are described. However, the following examples are provided for illustrative purpose only and are not to be construed to limit the scope of the present disclosure.

### Preparation Example 1: Preparation of First Particle in Form of Secondary Particle

An iron phosphate precursor (Fe₁PO₄), lithium carbonate, and titanium dioxide were mixed in a molar ratio of about 1:1.03:0.03. 10 wt % of glucose was further added to the mixture. Wet grinding was performed on the mixture by ball milling. Heating and hydrothermal treatment was performed on the mixture in an oven tray at about 200° C. Wet grinding was again performed on the mixture, and the slurry mixture was dried over evaporation, through spray drying, under conditions of a spray pressure of about 20 MPa and a temperature of about 400° C. The dried mixture was calcined in a nitrogen atmosphere at about 750° C. for about 10 hours to obtain a first particle in the form of a secondary particle. The average size of the first particle was about 2.5 μm, and the average size of primary particles in the first particle was about 200 nm to about 300 nm.

### Preparation Example 2: Preparation of Second Particle in Form of Single Particle

An iron phosphate precursor (Fe₁PO₄), lithium carbonate, and titanium dioxide were mixed in a molar ratio of about 1:1.03:0.03. 10 wt % of glucose was added to the mixture. Wet grinding was performed on the mixture by ball milling. The mixture was dried over evaporation on a tray by heating, and then dried in a vacuum oven at about 120° C. for about 4 hours. The dried mixture was calcined in a nitrogen atmosphere at about 750° C. for about 10 hours. The calcined product was ground to obtain a second particle in the form of a single particle. The average size of the second particle was about 700 nm.

### Preparation Example 3: Preparation of Third Particle in Form of Secondary Particle

An iron phosphate precursor (Fe₁PO₄), lithium carbonate, and titanium dioxide were mixed in a molar ratio of about 1:1.03:0.03. 10 wt % of glucose was further added to the mixture. Wet grinding was performed on the mixture by ball milling. The slurry mixture was dried over evaporation, through spray drying, under conditions of a spray pressure of about 0.5 MPa and a temperature of about 230° C. The dried mixture was calcined in a nitrogen atmosphere at about 750° C. for about 10 hours to obtain a third particle in the form of a secondary particle. The average size of the third particle was about 5 μm, and the average size of primary particles in the third particle was about 100 nm to about 200 nm.

### Example 1: Preparation of Mixed Positive Electrode Active Material

The first particle according to Preparation Example 1, the second particle according to Preparation Example 2, and the third particle according to Preparation Example 3 were mixed in a mass ratio of about 85:7.5:7.5 to prepare a positive electrode active material.

### Example 2

The first particle according to Preparation Example 1, the second particle according to Preparation Example 2, and the third particle according to Preparation Example 3 were mixed in a mass ratio of about 75:12.5:12.5 to prepare a positive electrode active material.

### Example 3

The first particle according to Preparation Example 1, the second particle according to Preparation Example 2, and the third particle according to Preparation Example 3 were mixed in a mass ratio of about 65:17.5:17.5 to prepare a positive electrode active material.

### Example 4

The first particle according to Preparation Example 1, the second particle according to Preparation Example 2, and the third particle according to Preparation Example 3 were mixed in a mass ratio of about 50:25:25 to prepare a positive electrode active material.

### Comparative Example 1

A positive electrode active material was prepared only with the first particle according to Preparation Example 1.

### Comparative Example 2

A positive electrode active material was prepared only with the second particle according to Preparation Example 2.

### Comparative Example 3

A positive electrode active material was prepared only with the third particle according to Preparation Example 3.

### Comparative Example 4

The first particle according to Preparation Example 1 and the second particle according to Preparation Example 2 were mixed in a mass ratio of about 70:30 to prepare a positive electrode active material.

### Comparative Example 5

The first particle according to Preparation Example 1 and the third particle according to Preparation Example 3 were mixed in a mass ratio of about 70:30 to prepare a positive electrode active material.

### Comparative Example 6

The second particle according to Preparation Example 2 and the third particle according to Preparation Example 3 were mixed in a mass ratio of about 70:30 to prepare a positive electrode active material.

### Preparation of Positive Electrode

95 wt % of a final positive electrode active material, 3 wt % of a polyvinylidene fluoride binder, and 2 wt % of a carbon black conductive material were mixed in an N-methylpyrrolidone solvent to prepare a positive electrode active material slurry. The positive electrode active material slurry was applied to an aluminum current collector and dried, and then rolling was performed to prepare a positive electrode.

### Manufacture of Rechargeable Lithium Battery

The prepared positive electrode and a lithium metal counter electrode, as a counter electrode, were used to prepare a 2032-type coin half-cell. A separator (thickness: about 16 μm) formed of a porous polyethylene (PE) film was interposed between the positive electrode and the lithium metal counter electrode, and an electrolyte solution was introduced to manufacture a rechargeable lithium battery. The electrolyte solution obtained by mixing LiPF₆ of 1.3 M in a mixed solvent containing ethylene carbonate (EC), ethylmethyl carbonate (EMC), and dimethylene carbonate (DMC) in a volume ratio of about 3:4:3 was used as an electrolyte.

### Evaluation Example 1: Surface Analysis of Positive Electrode Active Material

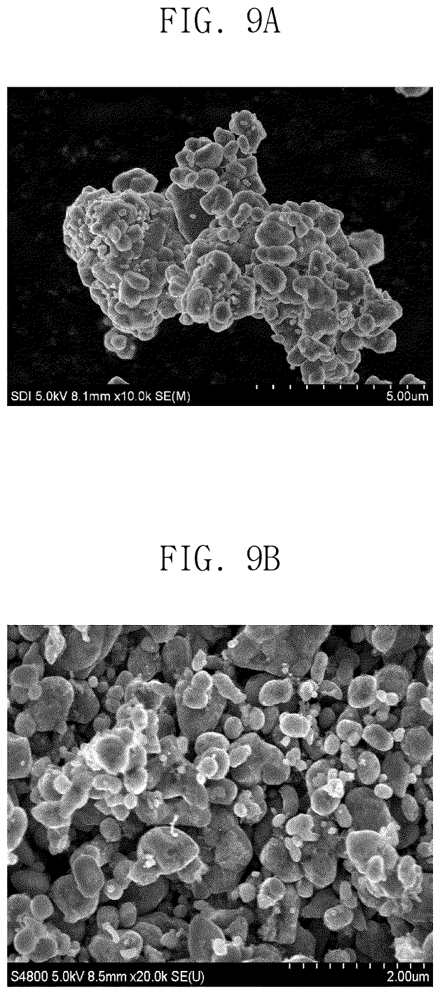

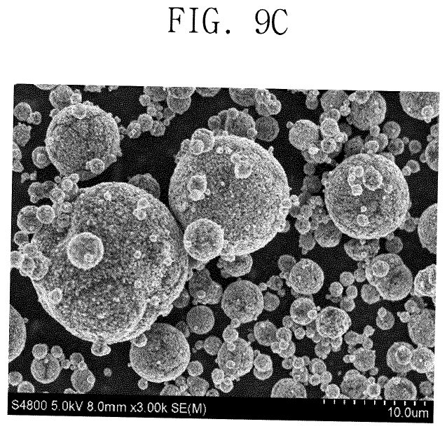

FIG. 9A shows a scanning electron microscope (SEM) image of the positive electrode active material prepared according to Preparation Example 1. FIG. 9B shows a SEM image of the positive electrode active material prepared according to Preparation Example 2. FIG. 9C shows a SEM image of the positive electrode active material prepared according to Preparation Example 3. Referring to FIG. 9A, it can be seen that the first particle, according to the preparation example of the present disclosure, has the form of a secondary particle in which a plurality of primary particles is aggregated, and is present in various shapes. Referring to FIG. 9B, it can be seen that the second particle according to the preparation example of the present disclosure is in the form of a nano-sized fine single particle. Referring to FIG. 9C, it can be seen that the third particle according to the preparation example of the present disclosure is in the form of a sphere-shaped secondary particle in which a plurality of primary particles is aggregated.

### Evaluation Example 2: Evaluation on Positive Electrode Characteristics

The current densities and mixture densities of the positive electrode plates according to Examples 1 to 4 and Comparative Examples 1 to 6 were measured, and the results were listed in Table 1.

TABLE 1

| | | | | Positive | |
|---|---|---|---|---|---|
| | Mixing ratio | | | electrode plate | |
| | First | Second | Third | Current | Mixture |
| | particle | particle | particle | density | density |
| | (wt %) | (wt %) | (wt %) | (mA/cm²) | (g/cc) |
| Example 1 | 85 | 7.5 | 7.5 | 2.8 | 2.2 |
| Example 2 | 75 | 12.5 | 12.5 | 3.0 | 2.5 |
| Example 3 | 65 | 17.5 | 17.5 | 3.5 | 2.8 |
| Example 4 | 50 | 25 | 25 | 4.0 | 3.0 |
| Comparative | 100 | 0 | 0 | 2.0 | 1.8 |
| Example 1 | | | | | |
| Comparative | 0 | 100 | 0 | 2.5 | 2 |
| Example 2 | | | | | |
| Comparative | 0 | 0 | 100 | 2.6 | 2.2 |
| Example 3 | | | | | |
| Comparative | 70 | 30 | 0 | 2.4 | 2.4 |
| Example 4 | | | | | |
| Comparative | 70 | 0 | 30 | 2.2 | 2.3 |
| Example 5 | | | | | |
| Comparative | 0 | 70 | 30 | 2.0 | 2.5 |
| Example 6 | | | | | |

Referring to Table 1, the positive electrode plates according to Examples 1 to 4 have higher current densities than the positive electrode plates according to Comparative Examples 1 to 6. In addition, the positive electrode plates according to Examples 1 to 4 have similar or higher mixture densities than the positive electrode plates according to Comparative Examples 1 to 6.

### Evaluation Example 3: Evaluation on Battery Characteristics

Lifespan characteristics of rechargeable lithium batteries prepared using the positive electrode active materials according to Examples 1 to 4 and Comparative Examples 1 to 6 were evaluated.

For initial charging and discharging, the rechargeable lithium batteries were initially charged under conditions of a constant current (0.2 C) and a constant voltage (3.65 V) at room temperature, were rested for about 10 minutes, and then discharged with a constant current (0.2 C) until a voltage reached 2.5 V. Thereafter, under 0.2 C/0.2 C conditions and at room temperature, the charging and discharging was performed by checking which cycle from the second cycle the capacity retention rate becomes about 80%. The capacity retention rate at an N-th cycle was calculated by Equation 1 below.

$$Capacity retention rate [ \% ] = [ discharge capacity at N - th cycle / discharge capacity at first cycle ] \times 100 \qquad Equation 1$$

TABLE 2

| | Mixing ratio | | | |
|---|---|---|---|---|
| | First | Second | Third | Rechargeable battery |
| | particle | particle | particle | Lifespan evaluation |
| | (wt %) | (wt %) | (wt %) | (SOH 80%) |
| Example 1 | 85 | 7.5 | 7.5 | 10,000 cyc or more |
| Example 2 | 75 | 12.5 | 12.5 | 10,000 cyc or more |
| Example 3 | 65 | 17.5 | 17.5 | 10,000 cyc or more |
| Example 4 | 50 | 25 | 25 | 10,000 cyc or more |
| Comparative | 100 | 0 | 0 | 4000 cyc |
| Example 1 | | | | |
| Comparative | 0 | 100 | 0 | 6000 cyc |
| Example 2 | | | | |
| Comparative | 0 | 0 | 100 | 7000 cyc |
| Example 3 | | | | |
| Comparative | 70 | 30 | 0 | 5500 cyc |
| Example 4 | | | | |
| Comparative | 70 | 0 | 30 | 6200 cyc |
| Example 5 | | | | |
| Comparative | 0 | 70 | 30 | 6600 cyc |
| Example 6 | | | | |

Referring to Table 2, the rechargeable batteries according to Examples 1 to 4 have more desired or improved capacity retention rates than the capacity retention rates of the rechargeable batteries according to Comparative Examples 1 to 6. Furthermore, the rechargeable batteries according to the examples have desired or improved lifespan characteristics with the capacity retention rates of at least about 80% after 10000 cycles.

A positive electrode active material according to an example embodiment of the present disclosure may have improved electrical conductivity, mixture density (compressed density, pellet density), and energy density. A rechargeable lithium battery according to an example embodiment of the present disclosure may have desired or improved lifespan characteristics.

Although the example embodiments of the present disclosure have been described with reference to the accompanying drawings, it is understood that the present disclosure should not be limited to these example embodiments but various changes and modifications can be made within the scope of the claims, the detailed description of the present disclosure, and the accompanying drawings, which also falls within the scope of the present disclosure.

What is claimed is:

1. A positive electrode active material comprising:
a first particle having an olivine crystal structure, and having a first average particle diameter;
a second particle having an olivine crystal structure, and having a second average particle diameter smaller than the first average particle diameter; and
a third particle having an olivine crystal structure, and having a third average particle diameter larger than the first average particle diameter,
wherein at least one of the first to third particles includes a compound represented by Formula 1 below: 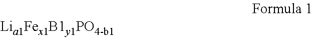
where, in Formula 1 above, 0.8≤a1≤1.2, 0.950≤x1≤0.999, 0.001≤y1≤0.05, 0≤b1≤0.05, and 0.99≤x1+y1≤1.01, and B1 comprises at least one of Ti and Mg.

2. The positive electrode active material of claim 1, wherein the first particle is a secondary particle including a plurality of first primary particles.

3. The positive electrode active material of claim 2,
wherein the first primary particle has an average size in a range of about 200 nm to about 350 nm, and
the first average particle diameter is in a range of about 1 μm to about 5 μm.

4. The positive electrode active material of claim 1,
wherein the first particle comprises a first coating layer containing carbon, and
an amount of carbon in the first particle is in a range of about 1.4 wt % to about 1.7 wt %.

5. The positive electrode active material of claim 1, wherein the first particle has a specific surface area in a range of about 8 m²/g to about 12 m²/g.

6. The positive electrode active material of claim 1, wherein a span value, obtained by analysis on the first particle using a particle size analyzer, is in a range of about 1.33 to about 1.5.

7. The positive electrode active material of claim 1, wherein the first particle has a porosity in a range of about 15% to about 20%.

8. The positive electrode active material of claim 1, wherein an amount of the first particle is in a range of about 60 wt % to about 85 wt % with respect to a total weight of the first to third particles.

9. The positive electrode active material of claim 1,
wherein the second average particle diameter is in a range of about 0.5 μm to about 2.5 μm, and
the third average particle diameter is in a range of about 5 μm to about 10 μm.

10. The positive electrode active material of claim 1,
wherein the second particle comprises at least one second primary particle, and
the third particle comprises a substantially sphere-shaped secondary particle including a plurality of third primary particles.

11. The positive electrode active material of claim 1, wherein a mixing ratio of the second particle to the third particle is in a range of about 1:1 to about 1:3 on the basis of weight.

12. The positive electrode active material of claim 1,
wherein at least one of the first to third particles comprises a coating layer containing carbon,
an amount of carbon on a surface of the first particle is greater than an amount of carbon on a surface of the second particle, and
the amount of carbon on the surface of the first particle is less than an amount of carbon on a surface of the third particle.

13. The positive electrode active material of claim 1,
wherein a porosity of the first particle is less than a porosity of the second particle, and
the porosity of the first particle is less than a porosity of the third particle.

14. A positive electrode for a rechargeable lithium battery, the positive electrode comprising:
a positive electrode current collector; and
a positive electrode active material layer on the positive electrode current collector,
wherein the positive electrode active material layer includes the positive electrode active material according to claim 1, a conductive material, and a binder.

15. The positive electrode of claim 14, wherein a current density of the positive electrode is equal to or greater than about 4.5 mA/cm².

16. The positive electrode of claim 14, wherein a mixture density of the positive electrode is equal to or greater than about 2.5 g/cc.

17. The positive electrode of claim 14, wherein an amount of the binder is in a range of about 0.5 parts by weight to about 5 parts by weight with respect to 100 parts by weight of the positive electrode active material layer.

18. The positive electrode of claim 14, wherein the binder comprises at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylate styrene-butadiene rubber, an epoxy resin, a (meth)acrylic resin, a polyester resin, and nylon.

19. The positive electrode of claim 14, wherein an amount of the conductive material is in a range of about 0.5 parts by weight to about 5 parts by weight with respect to 100 parts by weight of the positive electrode active material layer.

20. The positive electrode of claim 14, wherein the conductive material comprises at least one of a carbon-based material; a metal-based material in a form of a metal powder or a metal fiber; and a conductive polymer.
